(19) United States
(12) Patent Application Publication
(10) Pub. No.: US 2014/0068625 A1
(43) Pub. Date: Mar. 6, 2014

(54) DATA PROCESSING SYSTEMS

(71) Applicant: Paul Winser, Bristol (GB)

(72) Inventor: Paul Winser, Bristol (GB)

(21) Appl. No.: 13/880,416

(22) PCT Filed: Oct. 20, 2011
(86) PCT No.: PCT/GB2011/052043

§ 371 Date: Oct. 23, 2013

(30) Foreign Application Priority Data
Oct. 21, 2010 (GB) 1017756.6
Oct. 21, 2010 (GB) 1017757.4

(51) Int. Cl. G06F 9/50

(52) U.S. Cl. CPC G06F 9/5027
USPC 718/104

(57) ABSTRACT

A data processing system is described in which a hardware unit is added to a cluster of processors for explicitly handling assignment of available tasks and sub-tasks to available processors.

### BACKGROUND OF THE INVENTION

Computer processing systems are sometimes required to execute a large number of small individual tasks, either in quick succession or simultaneously. This may be because the system has a large number of independent processing contexts to deal with, or it may be because a large task has to be broken down in to smaller sub-tasks, for reasons such as limitations on data storage capacities.

Where higher overall processing performance is required, and the speed of an individual processor is limited by factors such as power consumption, a cluster of multiple processor cores may be used. It is common for multiple processing cores to be integrated on to a single integrated circuit.

Where there are one or more tasks to be executed, and where some of the tasks cannot be completed by a single processor, it may be necessary or desirable to divide the tasks into sub-tasks and allocated to multiple processors. One particular example of such a situation is that of a wireless signal digital processing system, where, for reasons of processing performance and efficiency, the continuous data stream representing the wireless signal is broken into fragments and distributed in turn to a number of processors. The processing requirements are not always known in advance, and may vary during and in response to the contents of the data stream being processed. For this reason, the coordination and direction of individual processors may not be simple and therefore mandates an operating scheme which is dynamic and flexible, and preferably under control of the software running on the processor cluster.

If the duration of processing of the sub-tasks is, by necessity, short in order to meet some processing limitations within the system, such as the amount of data an individual processor can store, then the management of coordinating and initiating individual tasks or sub-tasks may itself consume a considerable proportion of the available computing power.

### SUMMARY OF THE INVENTION

According to one aspect of the present invention, there is provided a data processing system for processing data items in a wireless communications system, the data processing system comprising a plurality of processing resources operable to process an incoming data stream in accordance with received task information, such task information relating to tasks concerned with wireless signal processing, a first list unit operable to store first list items relating to respective allocatable tasks, each first list item including information relating to at least one characteristic of a processing resource suitable for carrying out the task concerned, a second list unit operable to store second list items relating to available processing resources, and a hardware task assignment unit connected to receive said first and second list items, and operable to cause an allocatable task to be transferred to an available processing resource in dependence upon such received list items, wherein at least one of the processing resources is operable to store such first list items in the first list unit in dependence upon a processing result generated by the processing resource concerned, and wherein each of the processing resources is operable to store such second items in the second list unit in order to indicate the availability of the processing resource concerned.

According to another aspect of the present invention, there is provided A data processing system comprising a plurality of processing resources operable in accordance with received task information, a first list unit operable to store first list information relating to allocatable tasks, a second list unit operable to store second list information relating to available processing resources, and a hardware task assignment unit connected to receive said first and second list information, and operable to cause an allocatable task to be transferred to an available processing resource in dependence upon such received list information.

In such a data processing system, the first and second list units may be provided by the task assignment unit. In one example, the task assignment unit is operable to cause a processing resource from a dormant state to a processing state by allocation of a task to that processing resource.

The tasks may be selected from a group including determining pilot signals in such a data stream, generating data correction parameters for such a data stream, and providing feedback data for subsequent processing tasks.

Each such first list item may include task timing information. The first list unit may then include a plurality of task registers operable to store such list items.

Each such first list item may include a task descriptor.

Each such first list item may include address information indicating a location of a task descriptor.

Such a system may further comprise an input device connected for receiving task information, and an output device for transmitting task information. Such input and output devices, and the plurality of processing resources, may be connected to a shared data bus. Alternatively, the input and output devices, and the plurality of processing resources, may be connected via dedicated connection paths.

At least one of the processing resources may be operable to transfer data to be processed to another of the processing resources.

At least one of the processing resources may be operable to transfer data to be processed to another of the processing resources directly, or via a shared memory device.

At least one of the processing resources may be provided by a processing subsystem.

At least one of the processing resources may be provided by a processor unit.

At least one of the processing resources may be provided by a heterogeneous processing unit.

At least one of the processing resources may be provided by an accelerator unit.

According to another aspect of the present invention, there is provided a wireless communications system including such a data processing system.

In an embodiment of the present invention, a hardware unit is added to the cluster of processors to explicitly handle the assignment of available tasks and sub-tasks to available processors. The definition of the tasks can remain defined by software. The hardware unit decouples the timing of task generation and task initiation. It maintains lists of allocatable tasks and free processing resources. When both an allocatable task and a free processor resource both become listed, the unit assigns the task to the free processor.

The task assignment unit may be connected as a peripheral over the common processor memory bus, or have dedicated connections to individual processors.

Embodiments of the present invention may be elaborated to include heterogeneous processing resources and initiation of tasks at a specified point in time.

Moving the task assignment function from software to hardware has several advantages. The processors become more efficient since they no longer need to manipulate shared data structures such as lists of allocatable tasks and free processing resources, with the associated software execution time of such activities. The processors do not need to employ the special known techniques required for maintaining the integrity of data structures that are manipulated simultaneously by several processors. These techniques usually include special memory transaction types where both reading of and writing to a memory location are performed as an indivisible operation.

A processor does not need to perform hand-over of a task at a specific time dictated by the state of other processors. The hardware unit decouples the sending and receiving of task information in time, so that the sending processor has greater flexibility in its sequence of operation.

### BRIEF DESCRIPTION OF THE DRAWINGS

FIG. 1 shows a sequence in time of a data processing task being executed as multiple sub-tasks on several processors;

FIG. 2 shows a conventional processing system with multiple processors sharing a memory block and I/O block over a common bus;

FIG. 3 shows the addition of a task assignment unit to the shared bus;

FIG. 4 shows the general structure of a task assignment function;

FIG. 5 shows the task assignment unit with dedicated connections;

FIG. 6 shows an example of connections via both a shared bus and dedicated connections;

FIG. 7 shows examples of the task word format;

FIG. 8 shows the structure of the task assignment unit suitable for use in FIG. 6;

FIG. 9 shows two processing subsystems connected by a common task assignment unit;

FIG. 10 shows a task assignment unit capable of assigning tasks that have a specified commencement time; and

FIG. 11 shows the structure of the scheduled task store of FIG. 10.

### DETAILED DESCRIPTION OF THE PREFERRED EMBODIMENTS

When a computer system needs to execute a number of tasks simultaneously, it is common to assign tasks to available processing resources under the control of an Operating System, a software process which permanently resides in the system maintaining control of which tasks are being actively executed on which processor at any time. Often the operating system has an input from a timer which allows it to change the executing tasks at regular intervals, so that over time, all current tasks receive a share of the processing time.

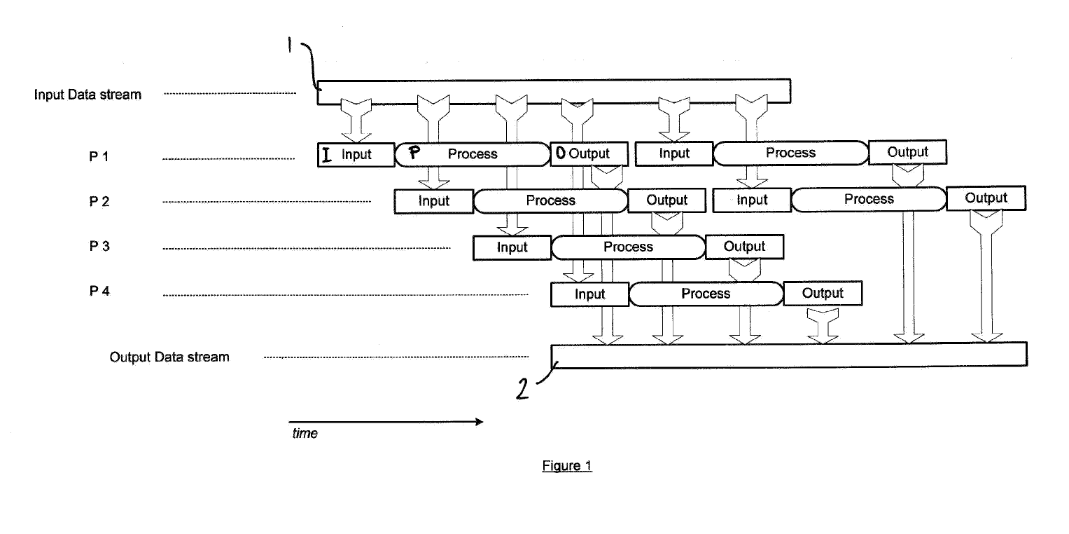

Managing the execution of tasks in this way may not always be appropriate. FIG. 1 shows a situation where a continuous stream 1 of input data is subject to processing to produce a continuous stream 2 of output data. This may be the case in a wireless signal processing system, for example. In the case shown, a cluster of four processors P1, P2, P3, P4 is used. This may be necessary due to limitations of processing speed or data storage of an individual processor. It can be seen that the operation of the four processors P1, P2, P3, P4 can be phased so that continuous processing of the data stream 1 is achieved, even though each individual processor requires an input phase, a processing phase and an output phase.

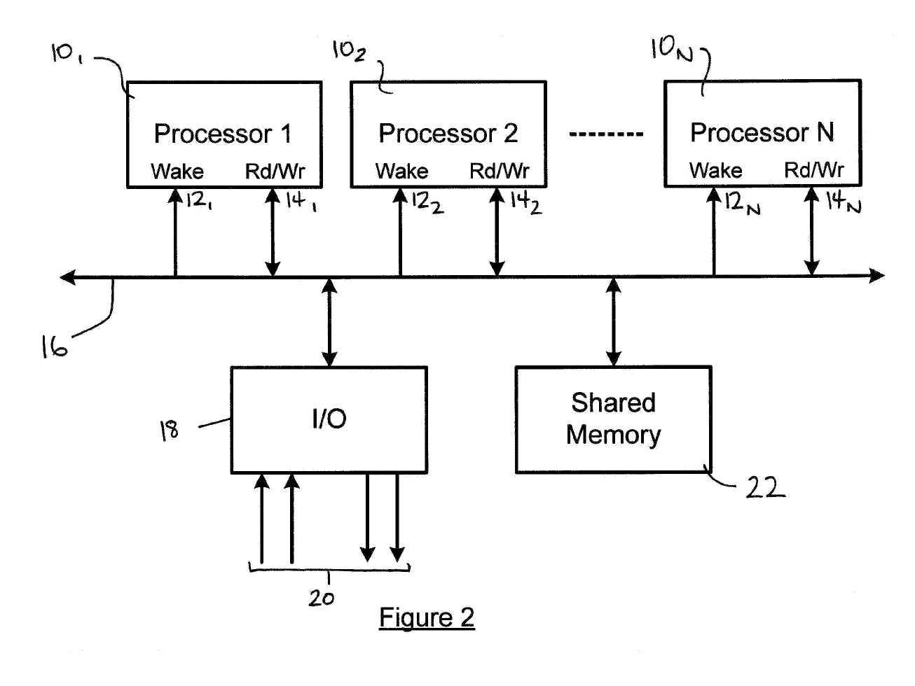

FIG. 2 depicts a cluster of N processors 10₁, 10₂ . . . 10_{N}, linked by an on-chip bus or communications network 16 to a shared memory block 22 and to an I/O block 18 through which the input and output data streams pass 20. In addition to their read/write ports (bus master) 14, each processor 10 also has a bus slave port 12 termed ‘Wake’ via which it can be awoken by another processor 10 or agent on the shared bus 16. A number of variations on this arrangement are possible—there may be more than one shared memory block 22 or I/O block 18. There may be a specialised control processor that has overall control of the system, such as generating tasks and monitoring the results of their completion. There may instead be several unconnected bus structures, for example a shared memory bus and a separate I/O bus, with separate connections to the processors. Data passing via the I/O block 18 may be streamed to or from the shared memory 22, or it may be stream directly to or from the processors 10 themselves.

In FIG. 1, only two of the four processors P1, P2, P3, P4 are in their processing phase at any time. This depiction is for the sake of clarity. Through the known technique of multiple data buffers within each processor, continuous operation of each processor is possible. In addition, buffering of the data streams means that actual processing does not need to be genuinely continuous, but may be interrupted for short periods between processing phases without undue effect on the overall operation, as long as the average processing rate is still sufficient to process the continuous data stream.

The kind of processing regime depicted in FIG. 1 is characterised by a task being fragmented into many short sub-tasks, or phases, arranged in a systematic way. As such, movement of tasks between processors must be very rapid and event-driven. Use of a standard software operating system would not achieve this in an efficient way.

Although substantially uniform as depicted in FIG. 1, the processing of the data stream will generally have a number of modes associated with different sections of the data stream. For instance it is common for wireless communication data to be in the form of discrete packets. The packets have a general form of a fixed header section followed by a variable length payload section. Additional sections such as error checking fields may follow the payload. There is generally more than one type of packet, each with its own structure. Information in the header section may indicate the nature of the processing that is to be performed on the payload. For these reasons, the coordination of multiple processors executing their processing phases must include a significant amount of flexibility, and be responsive to the contents of the data stream itself. The exact processing algorithm required for any one phase may depend on the results of the processing phase immediately preceding.

One embodiment of an aspect of the present invention provides a scheme whereby a processor is assigned a task by another processor or some other agent in the system such as an input/output block. The task has an associated task descriptor in shared memory that contains a complete description of the task to be completed. A processor that receives a task will determine how much of that task it is able to execute in one processing phase, given knowledge of its own processing and storage capabilities. It can then modify the task description in shared memory to reflect the amount of processing that it will perform, and then re-assign the task to another processor to continue execution of that task. In this way, processors can ‘hand over’ a task to each other, phase by phase, to generate the continuous processing pattern depicted in FIG. 1.

In addition to accessing the task descriptor in shared memory, a processor must have knowledge of at least one other processor that is available or ‘free’ to accept new ownership of a re-allocated task. In the operation depicted in FIG. 1, processors become free in a ‘round robin’ manner, and for any processor seeking to re-allocated a task, the same other processor will be free to accept it each time. As discussed above, FIG. 1 depicts a simple processing regime and in general there will be a less deterministic processing pattern, due to the variable length of processing phases and the presence of more than one task being executed.

In the general case there may be times where several tasks are defined ready for processing but no free processors are available. Conversely, there may also be times where several processors are free to accept a task but none are available. Clearly the operating model must be capable of handling both of these extreme cases, and all others in between.

One way of achieving this is to maintain a list of descriptors for tasks to be processed, and a list of processors that are free at any time. These lists could be held in shared memory where all processors have access to them. As each processor completes or hands over a task, it appends to the free list a system address that refers to its own command or ‘wake-up’ mechanism. It may then enter an idle or sleep state. It must also append itself to the free list upon initialisation of the system, in order to be able to accept its first task.

The data items to be processed by the next processor can be stored in a shared memory, or can be transferred directly from one processor to another. In the case where shared memory is used, the task descriptor stored in the task descriptor list will also contain address information for the data items to be processed.

Another processor seeking to hand over a task can remove an address entry from the free list and use it as the destination for a ‘wake-up call’ that re-allocates the task to that free processor. In the form of a conventional bus write operation, the address is that of the free processor's wake-up mechanism, and the data is the address of the task descriptor in shared memory that represents the task being re-allocated. The newly awoken processor can then use that address to read the task descriptor from shared memory and continue with execution of the task where the previous processor left off.

It should be noted that in the case where two or more tasks are being processed concurrently, the presence of multiple processors executing short processing phases allows the fair distribution of processing resources to the different tasks. The effective time-slicing of processor resources emulates that enforced by a conventional operating system, but without a central agent being in overall explicit control.

The task descriptor list and free list may be constructed and manipulated in shared memory, in ways that are well known in software engineering. The instruction sequences required to manipulate these lists may represent an undesirable burden on the processors, however, especially if the processing phases are relatively short. This problem is compounded by the fact that a single list structure in shared memory may be modified by more than one processor with arbitrary relative timings, such as the case when two processors both attempt to remove an entry from the free list at the same time. It is well known that in order to maintain the integrity of the list data structure under these conditions, special mechanisms must be employed to ensure that the list is only modified by one processor at a time. Often such mechanisms will include bus transaction types that can perform both a read and a write of a memory location as one indivisible operation.

Another drawback of the software mechanism described above is that of the timing of the hand-over of a task from processor A to processor B. It may be desirable to perform the hand-over early on in the processing phase of processor A, so that processor B has as much time as possible to initiate its phase. This may be important in maintaining continuous consumption of the input data stream. On the other hand, there may be no free processor available early in the processor A phase, meaning that an early attempt at handover would cause processor A to wait until processor B becomes free. This simply extends the time that processor A spends executing its phase.

This problem arises because of the coupling in time of the execution sequence of processor A and the availability of free processing resources. The coupling could be broken if the processors are multi-threaded, placing the list manipulation hand-over of the task in one thread and the actual processing instructions of the phase in another thread. The hand-over thread would then be initiated early in the phase, but would then suspend itself in favour of the processing thread, until such time as it is notified of another processor becoming free. This comes at the cost of the extra hardware required in the processors to maintain two processing threads, which can be a considerable overhead. It also requires some mechanism to re-invoke the hand-over thread depending on the contents of shared memory, perhaps by means of split transactions, support for which may also make the memory unit more complicated.

Embodiments of the present invention aim to solve these problems by casting the list management into hardware. This allows the processors to add an item to a list with a simple write operation. Assignment of tasks to free processors is directly handled by the hardware, avoiding the problems described above of list data integrity and optimum time of task hand-over.

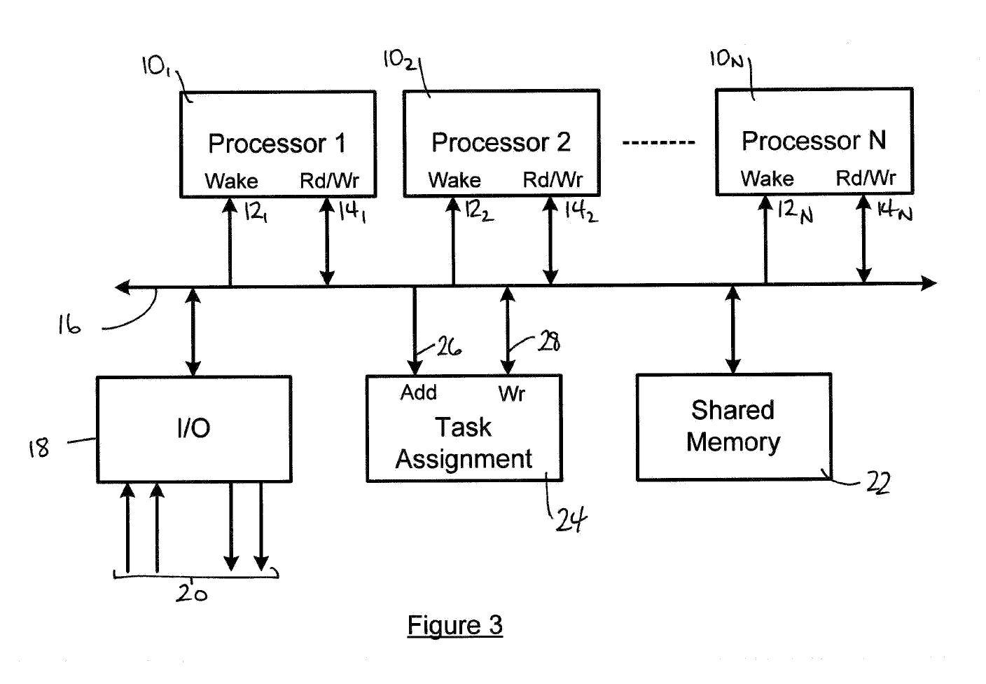

FIG. 3 is a version of FIG. 2 with the addition of a Task Assignment Unit 24. The task assignment unit 24 has a bus slave port 26 termed ‘Add’ to allow processors 10 to add items to the unit's internal lists, and a bus master port 28 by which means the unit can write the address of a task descriptor to the Wake port 12 of a processor 10.

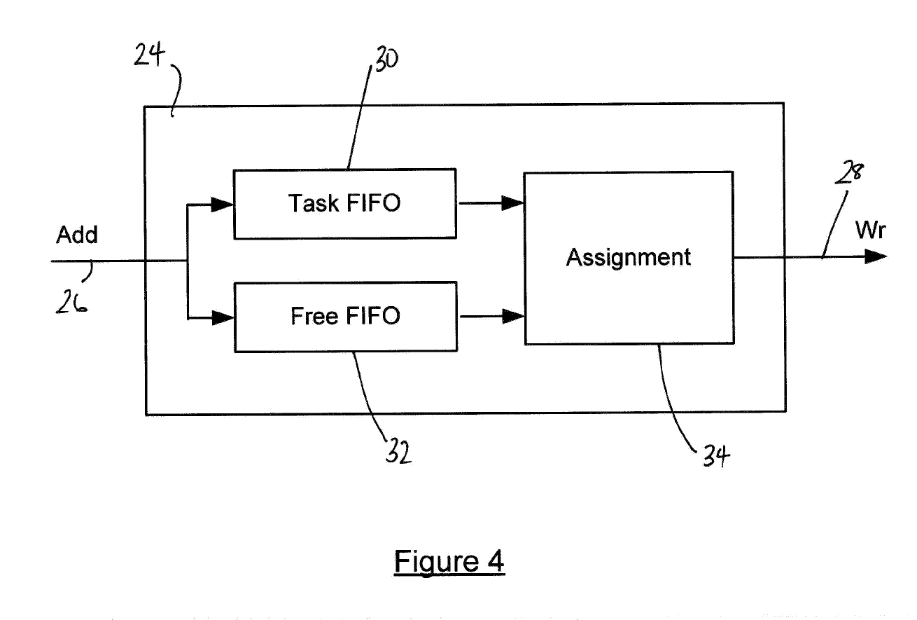

FIG. 4 shows one example internal arrangement of the task assignment unit 24. It contains a first FIFO buffer 30 which stores first list information forming a list of tasks to be performed, where each entry is an address of a task descriptor held in shared memory 22. The FIFO buffer 30 is initialised empty and its maximum depth is equal to the maximum number of tasks that may be in execution or waiting to be executed at any time. A second FIFO buffer 32 is used to store a list of available processing resources, for example in the form of addresses of the Wake ports 12 of free processors 10. The second FIFO buffer 32 is also initialised empty and its depth is equal to the number of processing resources present in the system. These two FIFO buffers 30 and 32 share the Add port 26 of the unit 24 on the shared bus 16, and are differentiated by being assigned different system addresses. A processor 10 that seeks to hand over a task to another processor 10 can write the address of the task descriptor to the address of the task FIFO buffer 30. A processor 10 which seeks to join the task sharing system, or which has completed a processing phase and which seeks to make itself available for another task, can write the address of its own wake port 12 to the address of the free FIFO buffer 32.

Whenever the entry counts of both FIFO buffers 30 and 32 are greater than zero, an entry from each is removed and combined in an act of task assignment 34. This generates a bus write operation in which the data is the entry removed from the task FIFO buffer 30, and the destination address is the entry removed from the free FIFO buffer 32.

By means of this hardware mechanism, a processor 10 may perform hand-over of a task early in its processing phase, but to the task assignment unit 24 instead of directly to another processor. The unit will immediately forward the task hand-over to a free processor 10 if it has one in its free FIFO buffer 32. Otherwise, the hand-over will be stored in the task list until a processor 10 adds itself to the free list. The unit 24 therefore performs the decoupling of hand-over operation in time from processor A to processor B that would otherwise have required multi-threading of the processors in order to function efficiently.

The list structures are described here as FIFO buffers in order to create one possible preferred policy of fair assignment of multiple tasks among multiple processors. Other policies are possible using different list structures. For instance, if the free list were implemented as Last In First Out (LIFO) buffer then the processor 10 which most recently became free would be assigned any new task. This scheme may be preferred under some power management policies.

The task assignment unit 24 would typically have an additional access means, not shown, by which a controlling processor could observe or alter the state of the FIFO buffers, for purposes of debugging the system operation or recovering from errors.

It should be noted that once a processor 10 has completed a processing phase and added itself to the free list, it remains inactive until it is awoken with a new task via its wake port. This inactive state may include measures to reduce its power consumption to a minimum, since it is not required to maintain the capability of waking itself up. Such measures may therefore include extensive clock gating or removal of power from a substantial part of the processor circuitry. Where such measures may take significant time to reverse when the processor is awoken with a new task, a policy may be chosen whereby the power saving mechanisms are only invoked if there is a high likelihood that the processor will not be awoken in the near future. The policy may therefore offer substantial power savings during periods of relative system inactivity, without incurring undue latency in rapid power-down and power-up sequences during busy processing periods.

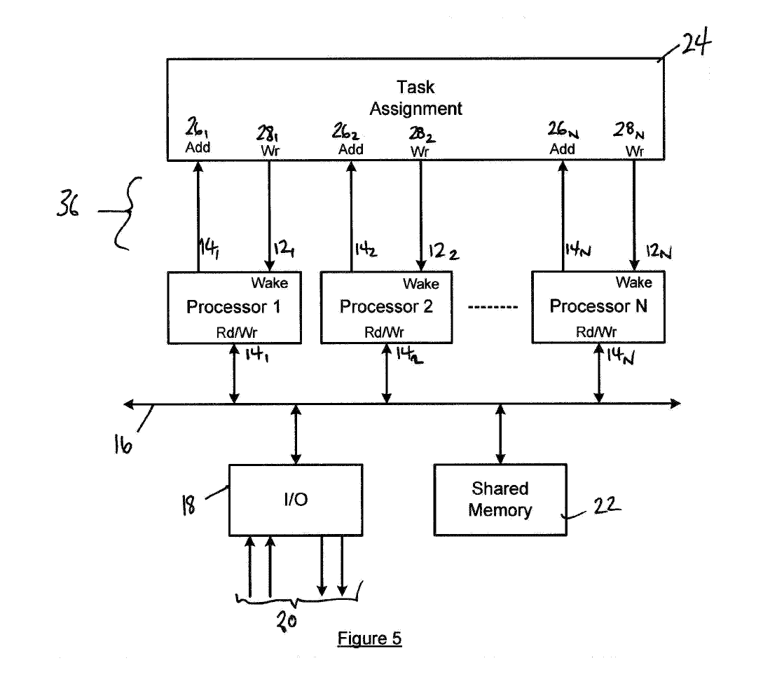

FIG. 5 shows an alternative system arrangement where the task assignment unit 24 does not reside on the main shared memory bus 16 but has dedicated connections 36 to each of the processors 10. In this case, the unit 24 combines the inputs from multiple Add ports 26 to its FIFO buffers. It must also decode the address of the generated task assignment write transaction in order to output the transaction on the correct port. Of course, a hybrid system can be arranged where some processors are connected via the shared memory bus and others have dedicated connections. This would embody aspects of both FIG. 3 and FIG. 5.

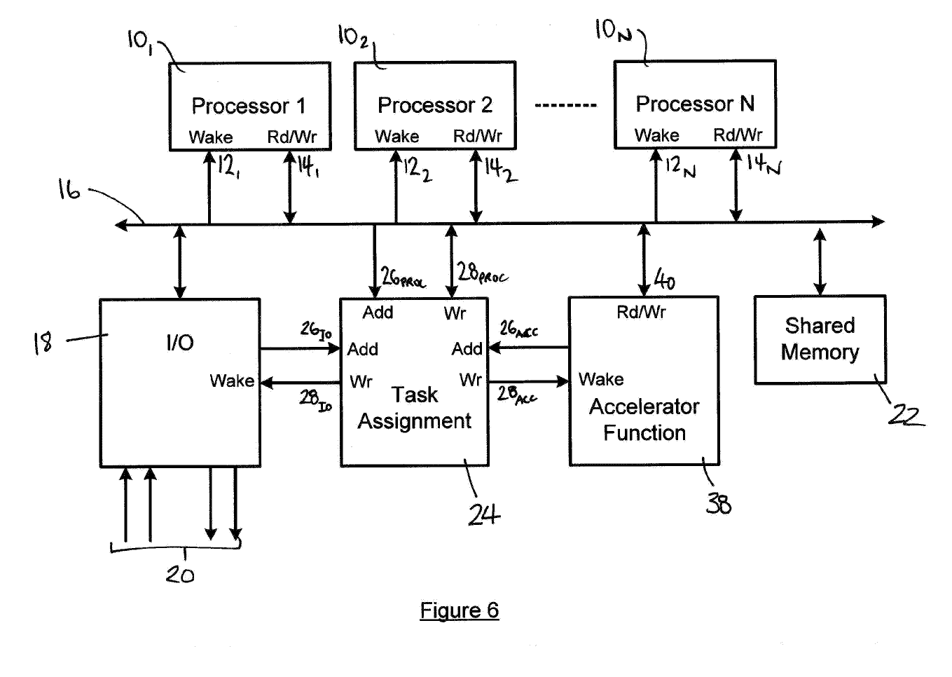

Such a hybrid system may be appropriate in a heterogeneous processing system, where in addition to general purpose processors there may also be special purpose processors or fixed hardware accelerators. Such units may have dedicated connections to the task assignment unit. FIG. 6 shows a system that includes a hardware accelerator function 38 with direct connections 26_{ACC}, 28_{ACC} to the task assignment unit 24. The accelerator function 38 also connects 40 to the bus system 16.

FIG. 6 also depicts the I/O block 18 having its own dedicated connections 26₁₀, 28₁₀ to the task assignment unit 24. This allows it to participate in the task sharing scheme, with the ability to both generate new tasks in response to incoming data, and perform some processing of its own as directed by the other processors 10.

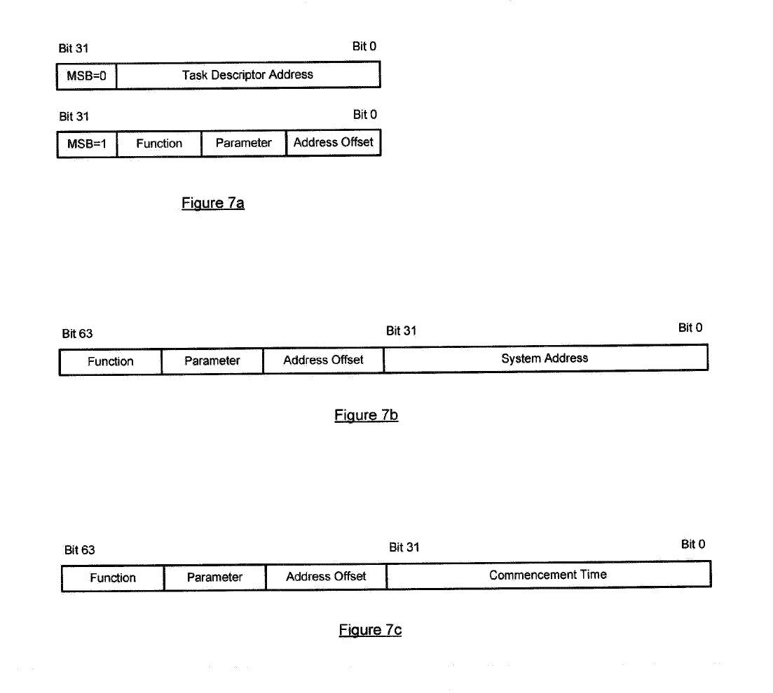

In the description above, tasks have descriptors that are stored in shared memory 22, and the address of that descriptor is what is transferred from one processor 10 to another, via the task assignment unit 24 in accordance with the present invention. Some tasks may require so little description that they can be defined in a single data command word. For example, the I/O block 18 depicted in FIG. 6 as participating in the task sharing scheme may have only two functions “input data” and “output data”. These functions may have one or more parameters such as length of data to transfer. It is likely that a single data word could be used to represent the function command and a length parameter, by sub-division of the data word into bit fields of the appropriate length. Such a command word could then be used in place of the task descriptor address, to define directly the task to be performed without need to fetch further information about the task from shared memory. It is common for system addresses to be 32-bits long. In most cases only a fraction of the available address space described by a 32-bit value is populated with memory, registers or other hardware structures. One possible encoding of the task descriptor word is as follows: if all valid system addresses were in the lower half of the address space, then a zero in the most significant bit (MSB) indicates that the word is an address of a task descriptor, and the processor being assigned the task must fetch the descriptor from that memory address. If the MSB=1, then the word is a direct task command with the lower 31 bits containing some encoding of function and parameters that is known to the processor. One or more of the parameters encoded could represent an address offset field. This allows the command word to refer to a data structure in memory, although since only a partial address is contained, it must be used as an offset to a known base address to form a full system address. This means that the address can refer to only a limited section of address space, whose size depends on the number of bits contained in the address offset field. FIG. 7a shows an example scheme where the 32-bit task word represents a full system address when the MSB=0, given that only the lower half of the address space is populated. If MSB=1 then the task word represents a command with a defined function code, one parameter and one address offset. It is obvious that many different such encodings are possible. If the task word were to be 64 bits in length, as is a common length for data words, then it could contain a full 32-bit system address in addition to other fields such as a function specifier and parameters etc. as shown in FIG. 7b. This allows a partial specification of the task in the task word itself, together with a reference to a system address that may contain further task descriptor information or may be the address of a data buffer, for example.

Where heterogeneous processing resources are present in the task sharing scheme, preferably there should be a mechanism to ensure that tasks are assigned only to appropriate resources that are able to execute them. In the description above the example is given where the I/O block 18 can perform tasks “input data” and “output data”. Clearly such tasks must always be assigned to an I/O block and not to another type of processing resource. In general, there may be a variety of resource types and a variety of task types, with an arbitrary mapping of which types of task can be executed on which resources. The task assignment unit 24 therefore needs to be provided with a means, when it has a new task to assign, of selecting a processor resource from its free list that is capable of executing the task, and ignoring those that are not. This requires some elaboration of the simple FIFO queue structure shown in FIG. 4. The order in which free processors are assigned tasks will no longer depend only on the order in which the unit is notified of them. The types of processor capable of performing those tasks must also be taken into account.

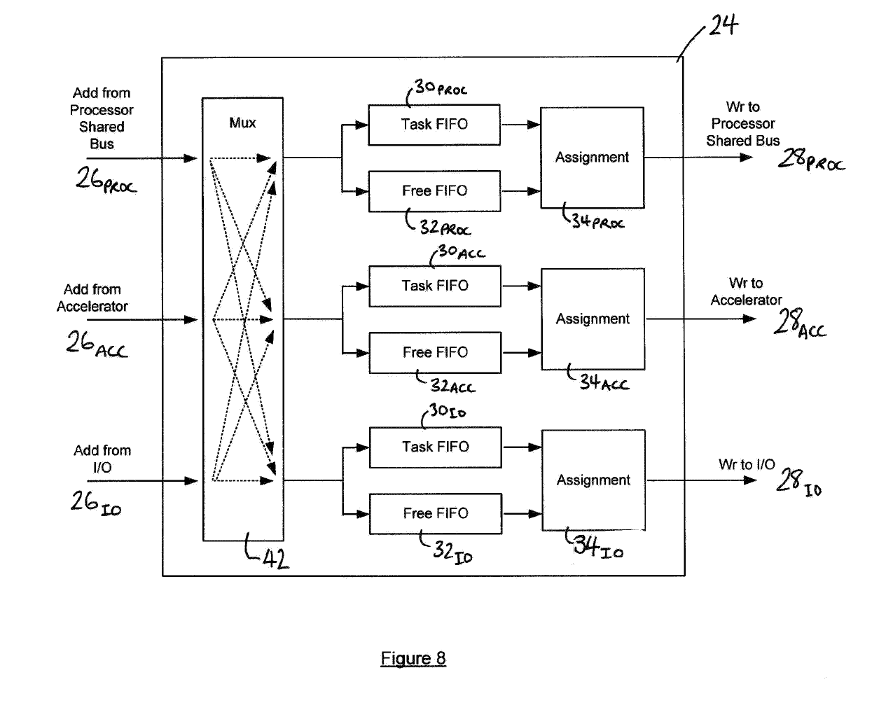

FIG. 8 shows a modified task assignment unit 24 that reflects the heterogeneous processing system shown in FIG. 6. In FIG. 8, the task assignment block of FIG. 4 is replicated three times 30_{PROC}, 30_{ACC}, 30_{IO}; 32_{PROC}, 32_{ACC}, 32_{IO}; 34_{PROC}, 34_{ACC}, 34_{IO}, once for each resource type (processor, accelerator, input/output), to form the whole task assignment unit 24. Since all the processors are connected via a common shared bus, and are identical as processing resources, they share both common connections and a single assignment unit. The single accelerator function and single I/O unit both have dedicated assignment blocks. These blocks work independently and in parallel to match up tasks and free resources of any particular type.

Since any type of resource can hand over a task to any other type of resource, there is a multiplexer 42 at the inputs 26_{PROC}, 26_{ACC}, 26_{IO} of the task assignment unit 24 that routes the addition of task entries and free entries to the appropriate assignment block 34_{PROC}, 34_{ACC}, 34_{IO}. This routing is performed by means of the address map of the individual FIFO buffers 30_{PROC}, 30_{ACC}, 30_{IO}, 32_{PROC}, 32_{ACC}, 32_{IO}, of which there are six in the example shown. When a processing resource hands over a task, it must write the task word to the appropriate address for the task FIFO buffer 30 of the target resource type. Similarly, when a resource becomes free it must write its wake mechanism address to the correct FIFO buffer for its own type of resource.

The task assignment unit 24 shown in FIG. 8 has one pair of ports 26_{PROC}, 28_{PROC} to a shared processor bus and two pair of ports 26_{ACC},28_{ACC} and 26_{IO}, 28_{IO} to dedicated hardware units. Connections to more than one shared bus are possible.

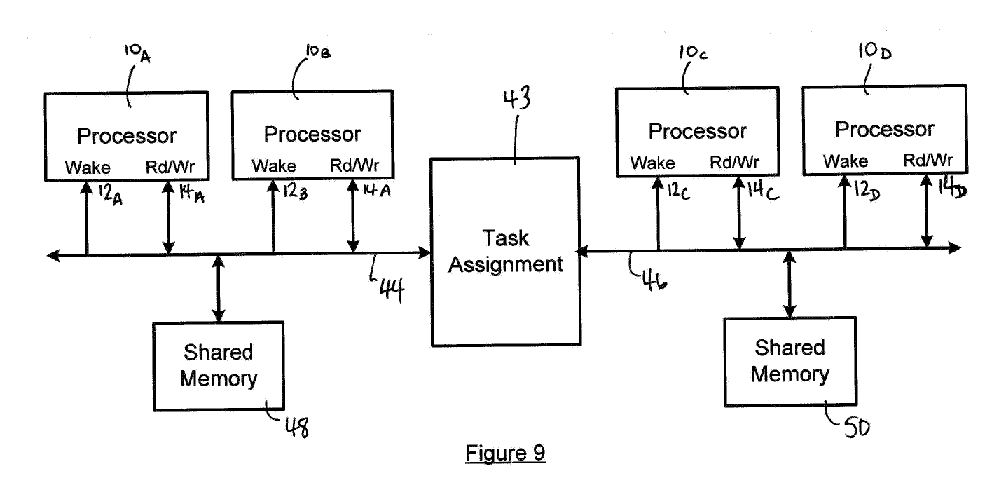

For example, FIG. 9 shows an arrangement where two complete processor clusters 10A and 10 B, 10C and 10D, each with their own bus connections 44 and 46 and shared memory 48 and 50, are connected via a task assignment unit 43. This may be a useful arrangement when each of the two subsystems deals with its own data and is substantially isolated from the other, but are related on a task level. Each subsystem may assign a task to the other via the unit. Depending on the nature of the tasks, some sharing of data may be required, which may be implemented through means such as a conventional dual-port buffer, not shown.

In some systems tasks may need to be started at a specified time, later than when the task description is generated. An example would be the output of data from the system being required at a particular time. The task assignment unit of the present invention can be elaborated to include this feature. It is assumed that the system contains a global clock function that generates a time code 55 for use by other parts of the system. The time code can be a binary number which is incremented at a regular interval that specifies the granularity of time keeping. The time code should be of sufficient number of bits that no ambiguity is caused when the timer ‘rolls over’ back to zero. In the example described below the time code is 32 bits.

In the above description of the task assignment hardware, a FIFO queue is used to decouple in time the hand-over of a task by processor A from its assignment to processor B. Deferring the assignment until a particular time has been reached is simply an extension of this mechanism. It is possible that a number of tasks are scheduled to begin in the future, at arbitrary times. The order in which they are generated may bear no relation to their scheduled times of commencement, preventing the use of a simple FIFO or LIFO queue to store them, since the next task to be assigned—the one with the lowest commencement time, may be any of those that have been scheduled.

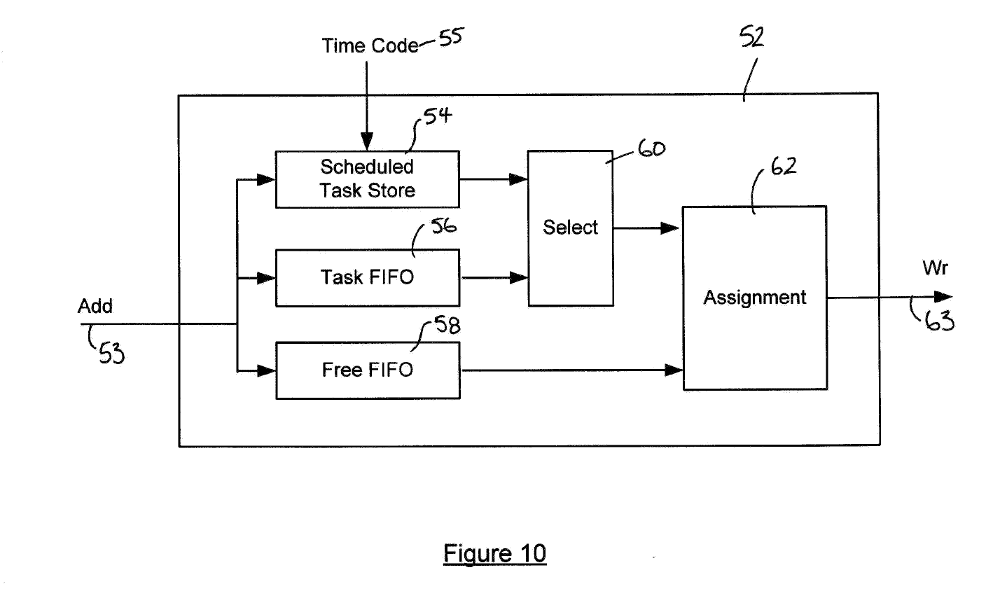

The basic function shown in FIG. 4 is elaborated to include timed tasks as shown in FIG. 10. In addition to the task FIFO buffer 56 and free FIFO buffer 58, there is a second storage unit termed Scheduled Task Store 54 for task words that have commencement times associated with them. This new store is address-mapped to task generating processing resources in the same manner as the original FIFO buffers. It has access to the global time code and makes available on its output any stored task word that has reached its specified commencement time. If no stored tasks are due, it presents no output. If several tasks have reached or passed their due time, they are queued at the output of the store, in their due time order. The block 60 termed Select can convey a task word from either of its two inputs to the Assignment block 62 where it is married with a free processor resource supplied from the free FIFO buffer 58. If presented with a valid task word on both of its inputs, the Select block will always favour the input from the scheduled task store, to give priority to timed tasks over untimed ones.

The timed task function can be combined with any of the system examples described above and depicted in FIGS. 3, 5, 6, 8 and 9.

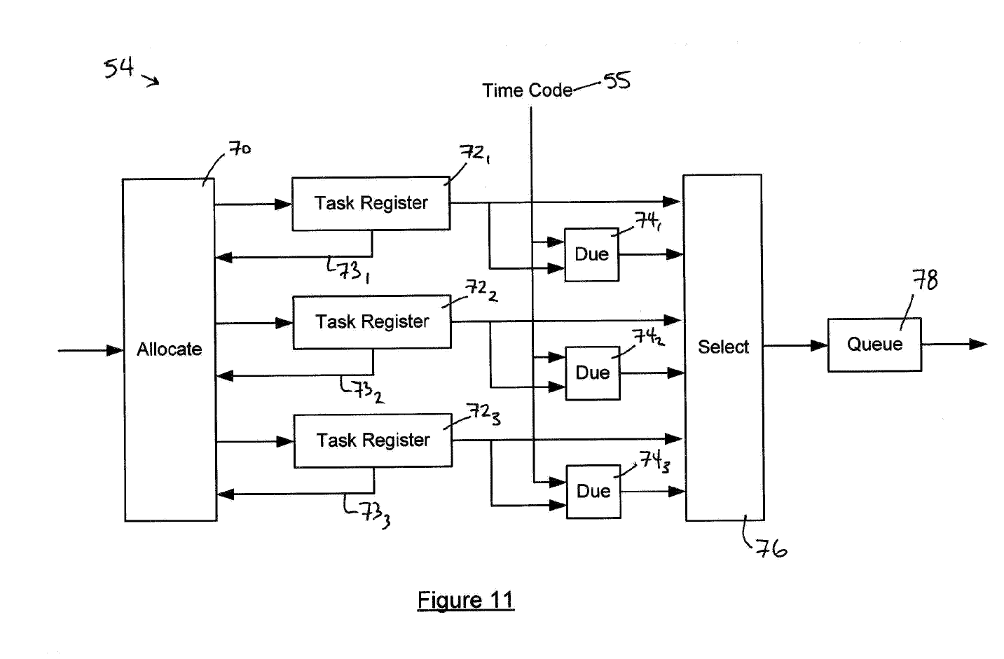

FIG. 11 shows the workings of the Scheduled Task Store 54. A number of Task Registers 72₁ . . . 72₃ are provided, equal to the maximum number of timed tasks that may be outstanding at any time for the particular resource type in question. In the example of FIG. 11 the number is three, although it will be readily appreciated that any appropriate number of registers can be provided. The block 70 termed Allocate passes an incoming task word to any task register 72 that is empty. If more than one task register 72 is empty, the choice is arbitrary. There is a status feedback 73 from each task register 72 to the allocating block to indicate whether the corresponding register 72 is occupied or not. The contents of every register is independently compared to the time code 55 input in the blocks 74 termed Due, and the results made available to a Select block 76. The select block 76 accepts transfer of a task word from its register 72 to an output queue 78 once the task commencement time has been reached. Upon transfer from a register 72, that register 72 becomes empty and signals the allocate block 70 that it can accept a new task word. The output queue 78 must be at least as deep as the maximum number of timed tasks that may be outstanding for this resource type.

An example encoding of commencement time in the task word is shown in FIG. 7c. Here the 32-bit System Address field of FIG. 7b is replaced by the desired 32-bit commencement time.

1-19. (canceled)

20. A data processing system for processing data items in a wireless communications system, the data processing system comprising:
a plurality of processing resources operable to process an incoming data stream in accordance with received task information, such task information relating to tasks concerned with wireless signal processing;
a hardware task assignment unit including:
a first list unit comprising a plurality of task registers operable to store first list items relating to respective allocatable tasks, each first list item including information relating to at least one characteristic of a processing resource suitable for carrying out the task concerned, and containing information relating to task timing information for the task concerned;
a second list unit operable to store second list items relating to available processing resources,
the hardware task assignment unit being operable to cause an allocatable task to be transferred to an available processing resource in dependence upon such first and second list items,
wherein at least one of the processing resources is operable to store such first list items in the first list unit in dependence upon a processing result generated by the processing resource concerned, and
wherein each of the processing resources is operable to store such second items in the second list unit in order to indicate the availability of the processing resource concerned, and
wherein the hardware task assignment unit is operable to cause a processing resource to move from a dormant state to a processing state by allocation of a task to that processing resource.

21. The data processing system as claimed in claim 20, wherein the tasks are selected from a group including extracting signal quality characteristics from such a data stream, generating data correction parameters for such a data stream, and providing feedback data for subsequent processing tasks.

22. The data processing system as claimed in claim 20, wherein each such first list item includes a task descriptor.

23. The data processing system as claimed in claim 20, wherein each such first list item includes address information indicating a location of a task descriptor.

24. The data processing system as claimed in claim 20, further comprising an input device connected for receiving task information, and an output device for transmitting task information.

25. The data processing system as claimed in claim 20, further comprising an input device connected for receiving task information, and an output device for transmitting task information, wherein the input and output devices, and the plurality of processing resources, are connected to a shared data bus.

26. The data processing system as claimed in claim 20, further comprising an input device connected for receiving task information, and an output device for transmitting task information wherein the input and output devices, and the plurality of processing resources, are connected via dedicated connection paths.

27. The data processing system as claimed in claim 20, wherein at least one of the processing resources is operable to transfer data to be processed to another of the processing resources.

28. The data processing system as claimed in claim 20, wherein at least one of the processing resources is operable to transfer data to be processed to another of the processing resources directly, or via a shared memory device.

29. The data processing system as claimed in claim 20, wherein at least one of the processing resources is provided by a processing subsystem.

30. The data processing system as claimed in claim 20, wherein at least one of the processing resources is provided by a processor unit.

31. The data processing system as claimed in claim 20, wherein at least one of the processing resources is provided by a heterogeneous processing unit.

32. The data processing system as claimed in claim 20, wherein at least one of the processing resources is provided by an accelerator unit.

33. A wireless communications system including a data processing system as claimed in claim 20.
